(19) United States
(12) Patent Application Publication
(10) Pub. No.: US 2024/0257269 A1
(43) Pub. Date: Aug. 1, 2024

(54) DATA-BACKED CUSTOMIZABLE COMPENSATION ESTIMATION BASED ON DISPARATE ELECTRONIC DATA SOURCES

(71) Applicant: INTUIT INC., Mountain View, CA (US)

(72) Inventors: Brittany SUMARSONO, Richardson, TX (US); Prabhavathi KARAVADI, Frisco, TX (US); Andrew Van CAO, Little Elm, TX (US); Laura Anne GRETHER, Oak Point, TX (US)

(21) Appl. No.: 18/159,708

(22) Filed: Jan. 26, 2023

(51) Int. Cl. G06Q 40/12

(52) U.S. Cl. CPC G06Q 40/125

(57) ABSTRACT

Aspects of the present disclosure relate to data-backed compensation estimation based on disparate electronic data sources. User data, Client data, External data, and Legal standard data are used to identify “Like Me” entities and to determine degrees of reasonableness of compensation for “Like Me” entities. User data includes various information about the user and the company from which the user is being compensated. Client data includes data about other entities which may be like the user. External data includes data which may factor in adjusting the value or reasonableness of a compensation amount. Legal standards may determine that a compensation amount is or is not reasonable for an entity. Estimates for reasonable compensation may be based on the “Like Me” entities in consideration of external factors and legal standards relevant to reasonableness of the compensation for that entity.

### INTRODUCTION

Aspects of the present disclosure relate to data-backed customizable compensation estimation for determining a reasonable compensation amount based on disparate electronic data from multiple sources.

### BACKGROUND

Many different factors influence what compensation amount or range is considered reasonable for an individual in a particular scenario. Financial advisors, S-Corporation owners, and other types of individuals may have an interest in optimizing their or a client's compensation. Compensation may be sub-optimal if it is too low or too high. If the amount is too high-valued, the compensation may be considered unreasonable and/or may be subject to taxes or penalties to the individual for which the compensation applies.

Traditionally, a tax advisor would manually prepare a recommendation for compensation. Such traditional recommendations are prepared using a manual method such as profit percentage. Reports containing market data analysis can provide a recommendation for compensation, but fail to take into consideration additional factors and characteristics of the individual and/or scenario. Since S-Corporation owner compensation, for example, may often be a relatively large amount, even small differences in how estimation of compensation is achieved may produce large differences in the resulting amount or range.

Reasonable Compensation (RC) reports may be used by advisors, valuators, accountants, attorneys, or others for purposes of optimizing payrolls, maintaining tax compliance, and assessing risk, or for a variety of other reasons. However, such reports are traditionally limited in a variety of ways. For example, they may be manually composed, static documents, which may miss information, are prone to human error, and may become quickly outdated.

Furthermore, while there may be many types of electronic data related to a particular entity that are potentially useful in estimating reasonable compensation, these types of electronic data may be located in different electronic data sources and may be in various data formats. Furthermore, it may be difficult to determine which electronic data is most useful for estimating reasonable compensation for a given entity. As such, existing techniques for reasonable compensation estimation may be unable to make valuable use of the range of electronic data available.

Accordingly, there exists a need for systems and methods of reasonable compensation estimation that consider not only market data or tax advisor recommendations, but also additional factors and characteristics that allow finer and more optimal estimation of the reasonable compensation.

### BRIEF SUMMARY

Certain embodiments provide a method of data-backed compensation estimation for an entity. The method generally includes receiving a primary entity data set (or “user” data set), a secondary entity data set (or “client” data set), and an external data set. The primary entity data set comprises data about a primary entity or user, the secondary entity data set comprises data about one or more secondary entities or clients, and the external data set comprises data about one or more factors affecting reasonable compensation for an entity.

The method further includes identifying a secondary entity of the one or more secondary entities based on a likeness between the primary entity data set and the secondary entity data set, identifying a legal standard by determining the legal standard is relevant to a finding of reasonableness for a compensation amount of the secondary entity based on the secondary entity data set and the external data set, generating an estimate for a reasonable compensation for the primary entity, the estimate including the compensation amount of the secondary entity and an indication of the reasonableness of the compensation amount of the second entity based on the legal standard and the external data set, and providing the estimate.

Other embodiments provide processing systems configured to perform the aforementioned methods as well as those described herein; non-transitory, computer-readable media comprising instructions, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 is an example flow chart illustrating methods of data-backed reasonable compensation estimation for an entity, according to various embodiments.

FIG. 2 illustrates an example system using methods of data-backed reasonable compensation estimation, according to various embodiments.

FIG. 3 illustrates an example workflow for a system of data-backed reasonable compensation estimation, according to various embodiments.

FIG. 4 illustrates an example flow chart for a method of automatic user data integration for a system of compensation estimation, according to various embodiments.

FIG. 5 illustrates an example flow chart for automatic integration of external data for a system of compensation estimation, according to various embodiments.

FIG. 6 illustrates an example flow chart for automatic integration of legal standards for a system of compensation estimation, according to various embodiments.

FIG. 7 illustrates an example flow chart for a method of integrating “Like Me” data for a system of compensation estimation, according to various embodiments.

FIG. 8 illustrates a graphical user interface of a computing device of a system of compensation estimation, according to various embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and non-transitory computer-readable storage mediums for automatically estimating reasonable compensation for an entity in a customizable manner based on disparate electronic data sources.

In certain embodiments, a variety of different types of electronic data about a plurality of entities is retrieved, such as from one or more electronic data sources. The electronic data may be used to determine “Like Me” entities for a particular user, where a “Like Me” entity is an entity that is determined to share similar attributes with the particular user based on automated analysis of electronic data. For example, a user may provide attributes to a software application and/or the software application may retrieve attributes of the user from one or more electronic data sources (e.g., using credentials provided by the user and/or based on other search and/or data retrieval techniques). The attributes of the user may be compared to attributes of the plurality of entities that are included in the electronic data about the plurality of entities in order to determine which entities are most similar to the user (e.g., based on computing a similarity score or other similarity measure between the user and each of the plurality of entities).

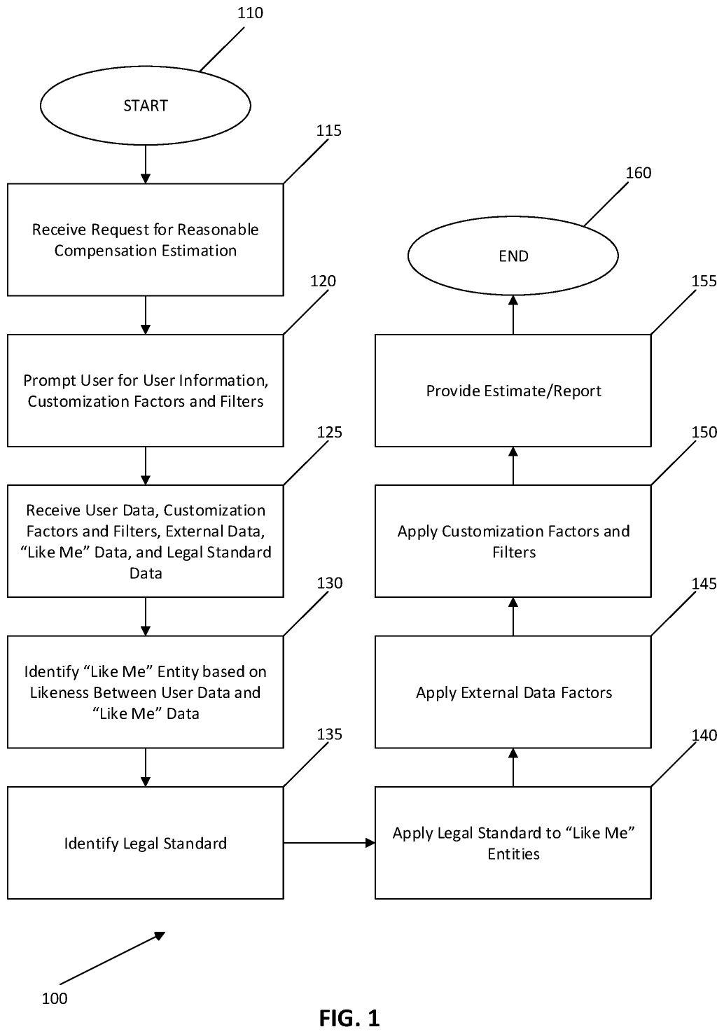

Determining “Like Me” entities for a given user allows for identification of the most relevant electronic data for use in estimating reasonable compensation for the given user, thereby avoiding the use of irrelevant, extraneous, and/or large amounts of electronic data in the automated estimation process. As described in more detail below with respect to FIGS. 1-8, a variety of electronic data points may be utilized in the estimation process, including compensation data of the “Like Me” entities, legal standard data applicable to the user and/or the “Like Me” entities, relevant external data, and/or the like. Furthermore, the user may be provided with the ability to customize the reasonable compensation estimation process, such as by providing input indicating particular data points, entities, electronic data sources, and/or the like for use in the automated estimation process. Customization factors indicated by the user may be used to further refine the set of electronic data used in the automated estimation process.

A reasonable compensation estimate may be automatically determined as described herein, and may be provided to the user (e.g., via a user interface), such as in the form of one or more ranges. Embodiments of the present invention improve reasonable compensation estimation in a number of ways. Improved “Like Me” entity selection improves the reasonable compensation estimation by automatically accounting for external factors such as recent market data, inflation, etc. The entities may be automatically evaluated with relevant legal standards for reasonableness and tagged, colored, or weighted accordingly and received by a user in the form of a recommendation or report. Unlike a traditional RC report, a report generated according to techniques described herein may automatically account for updates and external factors, the addition of new “Like Me” entities, and/or changes to a legal standard on an ongoing and dynamic basis. This leads to a greater optimization of reasonable wage estimation and an increased efficiency in acquiring supporting documentation. Further, the supporting documentation is easier to obtain and less prone to human error or bias. Additionally, by utilizing only data that is determined to be particularly relevant to a given user when automatically estimating reasonable compensation for the given user, such as based on “Like Me” entity determination and customization factors indicated by the given user, techniques described herein reduce the amount of electronic data that is utilized in a targeted manner, reduce utilization of computing resources, and thereby improve the functions of the computing devices involved while also improving the accuracy of the determined estimation. Certain embodiments also allow a user to provide feedback with respect to a reasonable compensation estimation generated as described herein for use in generating an updated reasonable compensation estimation, thereby providing a feedback loop by which the estimation process may be continuously improved.

FIG. 1 is an example flow chart illustrating methods of data-backed reasonable compensation estimation for an entity, according to various embodiments. In the example shown, the method 100 may begin at starting block 110 and proceed to stage 115 where a request for reasonable compensation estimation is received. For example, a user may request an estimate for the user or for another primary entity by interacting with a computing device such as a desktop or smart phone.

From stage 115 where the request is received, the method 100 may proceed to stage 120 where the user is prompted for user information, customization factors, and filters. For example, the user may enter the information into a graphical user interface of a computing device such as a desktop or smart phone. In some embodiments, prompting the user can include prompting the user for login information to an application or web service where some of the user information may be automatically determined, such as by including information already in use by a suite of products belonging to the user.

The user information may include, by way of non-limiting example, demographic features, geographical information, industry type, books data, tax data, salary data, and/or business characteristics data.

Demographic features may include, for example income, education, home ownership, marital status, family size, health-related factors, and/or other demographic information. The geographical information can include city, state, region, country, coordinates, height above sea level, or other geographical information. Industry type may include an industry, field of an industry, sub-field, or other industry type. The books data may include a business code, a number of employees, and/or number of shareholders. The tax data may include a gross receipts, a net profit, and/or average stockholder distribution. The salary data may include a state and/or job title. The business characteristics data include a level of qualification, a scope of work, and/or a complexity of work. The market data may include a favorability rating for market conditions and/or selections of whether to consider one or more related court cases. It will be appreciated that this is an exemplary but non-exhaustive list of possible data types and sub-types.

The customization factors may include a selection of which user data points, external data points, and/or legal standards to consider or ignore when determining “Like Me” matches. The filters may include a selection of results or result types to be included in an estimate, recommendation, or report.

From stage 120 where the user is prompted, the method 100 may proceed to stage 125 where user data, customization factors and filters, external data, other client data, and legal standard data are received. The types and sources of these factors and data are described in further detail below.

From stage 125 where the user data, customization factors and filters, external data, other client data, and legal standard data are received, the method 100 may proceed to stage 130 where one or more “Like Me” entities are identified based on a likeness between the user data and the other client data.

From stage 130 where the “Like Me” entities are identified, the method 100 may proceed to stage 135 where one or more legal standards are identified. According to various embodiments, the legal standards are identified using natural language processing of court cases or other legal sources, which may be available via electronic data sources such as websites or data repositories, to match terms of the legal source to the user based on the user data. However, legal standards or rules may also be manually selected without the use of automated natural language processing.

From stage 135 where one or more legal standards are identified, the method 100 may proceed to stage 140 where the one or more legal standards are applied to the “Like Me” entities. For example, if a legal standard supports a finding of reasonableness for a first value and a finding of unreasonableness for a second value, the “Like Me” entities may be assigned a degree of reasonableness as follows: for entities having compensation at or lower than the first value the degree is determined to be reasonable, for entities having compensation between the first value and the second value, the degree is determined to be possibly reasonable or unreasonable, and for entities having compensation greater than the second value the degree is determined to be unreasonable.

From stage 140 where the legal standards are applied, the method 100 may proceed to stage 145 where external data factors are applied. For example, an inflation rate or market trend rate may be applied to a “Like Me” entity to determine if an amount of compensation is reasonable or to adjust a value of a legal standard to compensate for current or changed market conditions.

From stage 145 where the external data factors are applied, the method 100 may proceed to stage 150 where the customization factors and filters are applied. A user may provide various customization factors and filters prior to receiving an estimate to determine what or how client data, external data, and legal standards are considered, included or weighted. A user may also toggle customization factors and filters after receiving a reasonable compensation estimate or report to generate an adjusted estimate or report in real time.

From stage 150 where the customization factors and filters are applied, the method 100 may proceed to stage 155 where an estimate or report is provided. In various embodiments, an estimate or report may include one or more of a dollar amount, a dollar range, an indication of relevant legal standards, and a histogram or other graphical representation of the “Like Me” entities with an indication of whether the amount of compensation for that entity is reasonable based on the relevant legal standards. Such a report may further include or have citations to documentation supporting the legal standards and findings of reasonableness, or may provide a clickable interface such as expandable tabs or hyperlinks providing information about the legal standard. From stage 155 where the estimate or report is provided, the method may complete at ending block 160.

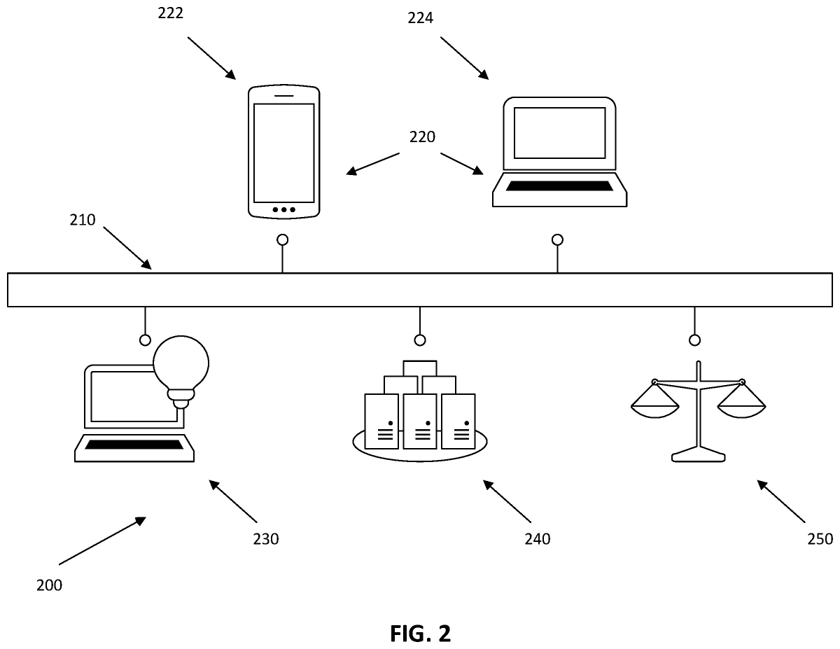

FIG. 2 illustrates an example system using methods of data-backed reasonable compensation estimation, according to various embodiments. As shown, the system 200 includes reasonable compensation estimate platform 210, which may be, for example, an application or web-based service. The platform 210 may be accessed by one or more user devices 220, for example a smart phone or tablet 222 or a laptop or desktop computer 224. In some embodiments, the user device or devices 220 may have a suite of products installed thereon containing user information used to determine a reasonable compensation estimate, or a user may use a user device to logon to an account for accessing a suite of web-based products containing user information used to determine a reasonable compensation estimate. This information may be included as a source of the user (or primary entity) data. Information may be reliably obtained, as it originated from the suite of products. Information may be cleaned for personal identifying information (PII). However, the data is still reflective of real client entities who may be like the primary entity in a determinable way. In this way, real and/or verified data for clients, including tax return data available to a suite of products, can be utilized without violating privacy requirements, while still retaining important client data.

The reasonable compensation estimation platform 210 may communicate electronically with other client devices 230. In particular, client devices or accounts containing client information matching the types of user information used for reasonable compensation estimate may be used as sources of client (or secondary entity) data. For example, a client device 230 may access a service and provide to the service information such as demographic features, geographical information, industry type, books data, tax data, salary data, and/or business characteristics data, which may be used by the platform 210 to generate “Like Me” profiles, whether or not the client device 230 uses or has logon access to the reasonable compensation estimation platform 210.

A particular source of client data may be tax return data, either filed or accepted. Tax return data may be used by an application, product, service, or account belonging to a suite of products. The tax return data may include, for example, demographic information, compensation information, and/or and other data that is used to generate and identify “Like Me” profiles. Further, multiple years of tax return data may be available to form a history of tax return data. The history of tax return data may be analyzed for trending data. In various embodiments, trending data may be given higher rank or weight when determining “Like Me” entities. Data received from such a suite of products further may be sanitized data having a specified data structure organizing the data types and values.

The reasonable compensation estimation platform 210 may communicate electronically with one or more datastores or web servers 240. In some embodiments, a datastore 240 stores user data and/or client data. In some embodiments, external data not related to a user or client (or primary or secondary entity) may be stored on a web server 240 and accessible to the platform 210. The external data can include, by way of non-limiting example, Bureau of Labor Statistics (“BLS”) data, stock market data, or other external data. The BLS data includes, for example, demographic information, geographic, and compensation amount data.

The reasonable compensation estimation platform 210 may communicate electronically with one or more legal databases 250. In various embodiments, the platform 210 may use natural language processing to identify relationships between sets of keywords and terms included in a legal document or other legal source. The relationships are used to identify one or more legal standards, and/or used to rank a group of legal standards by relevance to a user or a “Like Me” entity.

The legal sources may include a legal standard wherein a compensation amount is found reasonable (or unreasonable). The legal sources may further include, by way of non-limiting example, demographic features, geographical information, industry type, books data, tax data, salary data, and/or business characteristics data related to parties involved in legal actions involving reasonableness of compensation amounts. The platform 210 may determine matches between values for the types of user data and values belonging to a party in a legal action. For example, industry type data, geographical information data, etc. may contain matching values for a user, client, or party to a legal action. The matches may be used to identify legal standards relevant to a user or client. The legal standards may be used as a basis for supporting reasonableness of a compensation amount as it pertains to a user or client, to improve reasonable compensation estimation.

In various embodiments, external data may impact or determine whether a legal standard applies to a user or client. For example, a compensation amount of a user, client, or party to a legal action may be adjusted for external data. For example, an inflation rate may be applied to compensation amounts for client data and legal standards when determining a reasonableness of a particular compensation amount in present value. A compensation amount may also be adjusted for based on, for example, a market trend, growth in a market sector, or other external data factor.

In various embodiments, the platform 210 identifies “Like Me” entities or clients and/or generates “Like Me” profiles for one or more clients of the client data set that are like the user. The platform 210 then may determine a reasonableness for each client profile based on legal standards identified as relevant to that client or a like entity. The platform may generate an estimate by determining ranges of compensation amounts (1) for which all clients included in the range have reasonable compensation based on the legal standards; (2) for which some clients included in the range have reasonable compensation based on the legal standards but some clients included in the range do not have reasonable compensation based on the legal standards; and (3) for which all clients in the range do not have reasonable compensation based on the legal standards. Thus, an amount below the top of the first range is likely reasonable, but is less likely to be optimizing potential compensation. An amount in the second range may be at risk of being either reasonable or unreasonable, but is more likely to optimize potential compensation. An amount in the third range is likely not reasonable, but if reasonable would be most likely to optimize potential compensation. In various embodiments, the platform 210 may provide an estimate or report indicating these ranges.

In some embodiments, the compensation amounts of the client profiles may be weighted based on degree of reasonableness, and a suggested value or range may be provided to the user or included in a report. The report may include a histogram of client profiles, which may be identified, grouped, or colored by compensation amount, reasonableness, and/or likeness. In some embodiments, the “Like Me” client profiles and their associated data are viewable in the report. In various embodiments, the legal standards may be included in the report in the form of statements, summaries, or links to supporting legal documents. The report may be viewed, for example, in a web browser of a user device. However, such a report could also take the form of an electronic document, electronic message, physical document, etc.

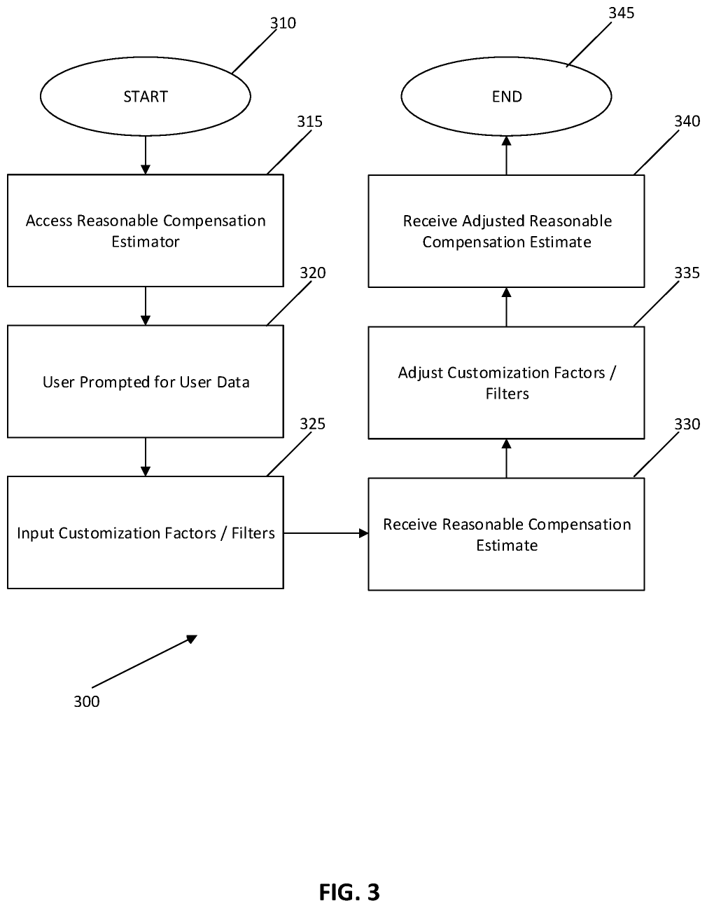

FIG. 3 illustrates an example workflow for a system of compensation estimation, according to various embodiments. As shown, the workflow 300 begins at starting block 310 and proceeds to stage 315 where a user accesses a reasonable compensation estimator. For example, a reasonable compensation estimator be as an application on a user device, or an estimator that is a part of a web service accessible by a user device. In some embodiments, the estimator may be a part of a suite of applications on a local user device or may be part of a suite of web services for which the user has access. In various embodiments, logon credentials may be used to access a user account for one or more applications or services of such a suite of applications or services.

From stage 315 where the user initiates the request, the workflow 300 may proceed to stage 320 where the user may be prompted for user data, such as by being presented with a form or questionnaire. In some embodiments, the user may provide credentials or approval to authorize user data to be imported, for example, from local storage associated with an application, or from remote storage associated with a web service. In other example cases, the user may already be logged in to such a service and the user data may be automatically detected and imported without requiring approval. The form or questionnaire may be prepopulated in whole or in part by user data extracted from the suite of applications or services, or from other sources accessible to the user device or to a service hosting the estimator.

From stage 320 where the user is prompted for user data, the workflow 300 may proceed to stage 325 where the user inputs customization factors and/or filters. The customization factors or filters may determine what results are included in generating the reasonable compensation estimate or report.

From stage 325 where the user inputs the customization factors and/or filters, the workflow 300 may proceed to stage 330 where the user receives a reasonable compensation estimate or report. From stage 330 where the user receives the estimate or report, the workflow may proceed to stage 335 where the user may adjust the customization factors and/or filters. In various embodiments, the user may also adjust values for the user data. In various embodiments, the user may also select individual legal standards or “Like Me” entities to consider or not consider. In still further embodiments, the customization factors and/or filters may include a default setting and/or one or more presets. The presets may enable a user to choose, save, or load a selection of customization factors or filters that has been preselected.

From stage 335 where the user may adjust the customization factors and/or filters, the workflow 300 may proceed to stage 340 where the user receives an adjusted reasonable compensation estimate. For example, a user may select one or more legal standards or “Like Me” entities to consider or not consider, which may cause the adjusted reasonable compensation estimate to be different than an original reasonable compensation estimate. The user may continue to adjust factors and/or filters, user data, or selection of legal standards and “Like Me” entities and receive an updated estimate based on one or more adjustments. From stage 340 where the user receives the adjusted reasonable compensation estimate, the workflow may end at ending block 345.

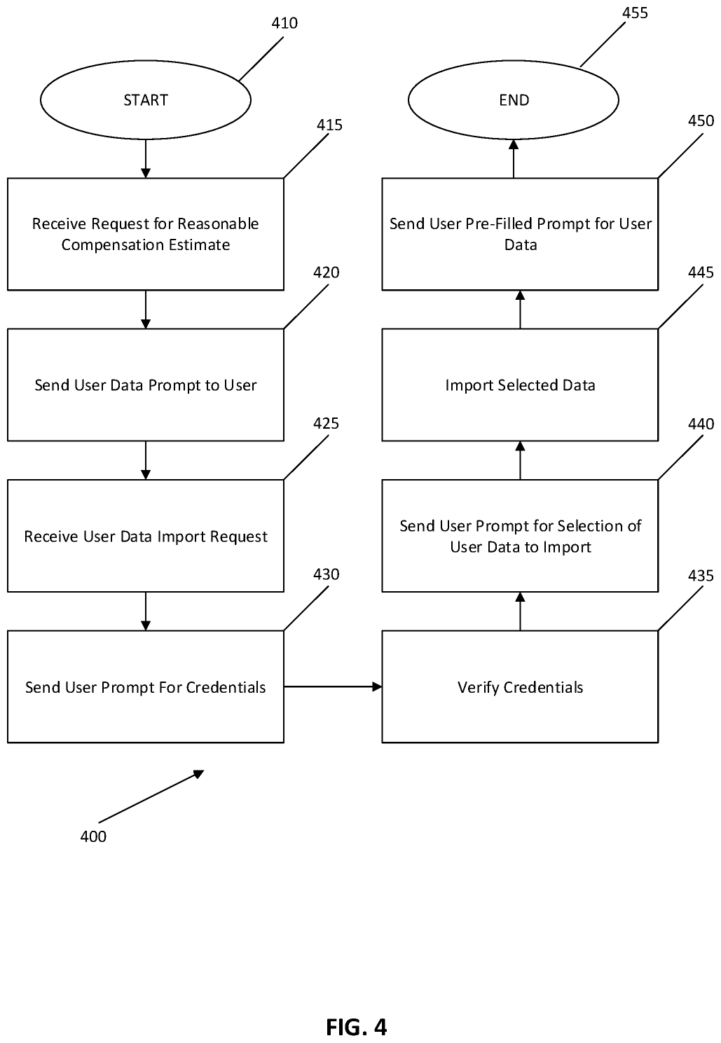

FIG. 4 illustrates an example flow chart for a method of automatic user data integration for a system of compensation estimation, according to various embodiments. As shown, the method 400 may begin at starting block 410 and may proceed to stage 415 where request for a reasonable compensation estimate is received. Such as by a user submitting a request through or accessing an application or web service.

From stage 415 where the request for an estimate is received, the method 400 may proceed to stage 420 where a prompt for user data is sent to the user, such as a form or questionnaire, is sent to the user. In some cases, such a form may be at least partially prepopulated with user data.

From stage 420 where the prompt for user data is sent to the user the method 400 may proceed to stage 425 where a request to import user data is received. In various embodiments, the user may initiate the request, or the user may be prompted for a selection of whether to import user data.

From stage 425 where the request to import user data is received, the method 400 may proceed to stage 430 where a prompt for credentials is sent to the user. For example, the user data to be imported may require a login to a service to be accessible. From stage 430 where the prompt for credential is sent to the user, the method 400 may proceed to stage 435 where the credentials are verified. For example, the credentials may be login information to a service hosting or having access to the user data.

From stage 430 where the credentials are verified, the method 400 may proceed to stage 435 where a prompt for a selection of user data to be imported may be sent. For example, a user may select one or more products or services of a suite of products or services to import data from, or may select from or filter available user data by account, year, type, etc.

From stage 435 where the prompt for a selection of user data to be imported is sent, the method 400 may proceed to stage 440 where the selected data is imported. From stage 440 where the selected user data is imported, the method 400 may proceed to stage 445 where a pre-filled prompt for user data is sent to the user. For example, a form or questionnaire that has been at least partially pre-populated with values imported from the selected user data may be provided to a computing device belonging to the user. From stage 445 where the pre-filled prompt is sent to the user, the method 400 may proceed to end at ending block 450.

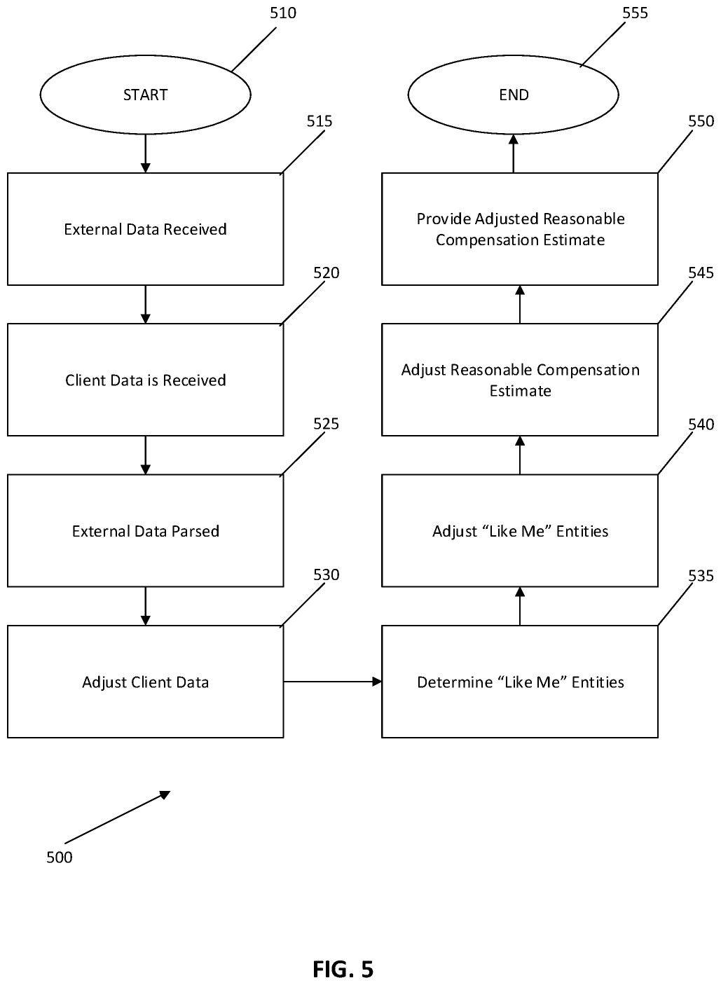

FIG. 5 illustrates an example flow chart for a method of automatic integration of external data for a system of compensation estimation, according to various embodiments. As shown, the method 500 may begin at starting block 510 and proceed to stage 515 where external data is received. In some cases, the data may have a known, readable format or may be sanitized. External factors can be identified as factors for which there is a relationship between a data type included in the user or client data and a reasonable compensation amount. For example, BLS data includes compensation information that is related to demographic and/or geographic information, which may be factors that support weighting or adjusting a compensation amount according to demography or geography. Data points may be collected from the external data to identify external data factors affecting reasonable compensation. The factors may be used to generate or adjust “Like Me” profiles.

From stage 515 where the external data is received, the method 500 may proceed to stage 520 where client data is received. The client data can include one or more client entities having a compensation amount and other client data. From stage 520 where the client data is received, the method 500 may proceed to stage 525 where the external data is parsed for data points relevant to reasonable compensation for entities of the user data generate an external data set. For example, market trend data or inflation data may suggest a value of a compensation amount would be considered reasonable in light of the data but unreasonable without the data, or vice versa. The external data set may define external data factors tending to suggest a value of compensation for an entity should be adjusted to be higher or lower or to suggest a value of a compensation amount for an entity would or would not be considered reasonable.

From stage 520 where the client data is received, the method 500 may proceed to stage 525 where the external data is parsed. In some embodiments, the data may be parsed for external factors relevant to the client data, although the external data may be parsed prior to receiving client data in some cases. Client data points can be adjusted prior to the “Like Me” profiles being identified or generated to better determine likeness based on the external factors. However, it also appreciated client data for client entities can also be adjusted after being identified as “Like Me” data belonging to a “Like Me” entity. One or more client profiles may thus be generated or adjusted based on the external data and client data.

From stage 525 where the external data is parsed, the method 500 may proceed to stage 530 where client data is adjusted. For example, a data value for an existing “Like Me” entity may be adjusted based on the external data, or new “Like Me” entities can be identified based the external data. For example, tax return data may be sufficient for generating “Like Me” profiles, regardless of whether it is external tax return data or client tax return data.

As another example, the external data may include data points indicating factors that would tend to suggest a higher or lower value for a data value, which could affect whether an entity is a “Like Me” entity or another client entity. External Data related to, for example, market trends or growth in an industry, inflation, demographic information, or geographic information, etc. can be used to compensate or adjust for factors affecting the value of a gross receipts, which may be a factor in whether an entity is a “Like Me” entity.

Thus, the compensation amounts for “Like Me” profiles can be adjusted for various factors. The compensation amounts included in legal standards may also be adjusted for based on the same or similar factors. Therefore, these amounts may be normalized by the factors when used as a basis for comparison. For example, a compensation that was found unreasonable in a legal standard may be below an amount, but above than amount when adjustments for inflation, certain market data, or other factors are made. In some cases it may be desirable to adjust the compensation amount of a legal standard may be adjusted instead of or in addition to the “Like Me” amount for comparison. In this way, an improved comparison can be made between, for example, compensation amounts from different regions or years.

From stage 530 where client data is adjusted, the method 500 may continue to stage 535 where the adjusted client data is used to determine “Like Me” entities for a user by determining likeness between the adjusted client entity data or other entity data and data for that user to determine “Like Me” entities for that user.

From stage 535 where the “Like Me” Entities are determined, the method 500 may proceed to stage 540 where a reasonable compensation estimate is adjusted. For example, the external data may indicate a factor suggesting the value of reasonable compensation needs to be adjusted. In various embodiments, a value, range, or set or values or ranges for one or more entities are be adjusted.

From stage 540 where the reasonable compensation estimate is adjusted, the method 500 may proceed to stage 545 where the adjusted reasonable compensation estimate is provided. For example, the estimate may be provided via a graphical user interface of a user device. From stage 545 where the estimate is provided, the method 500 may proceed to conclude at ending block 550.

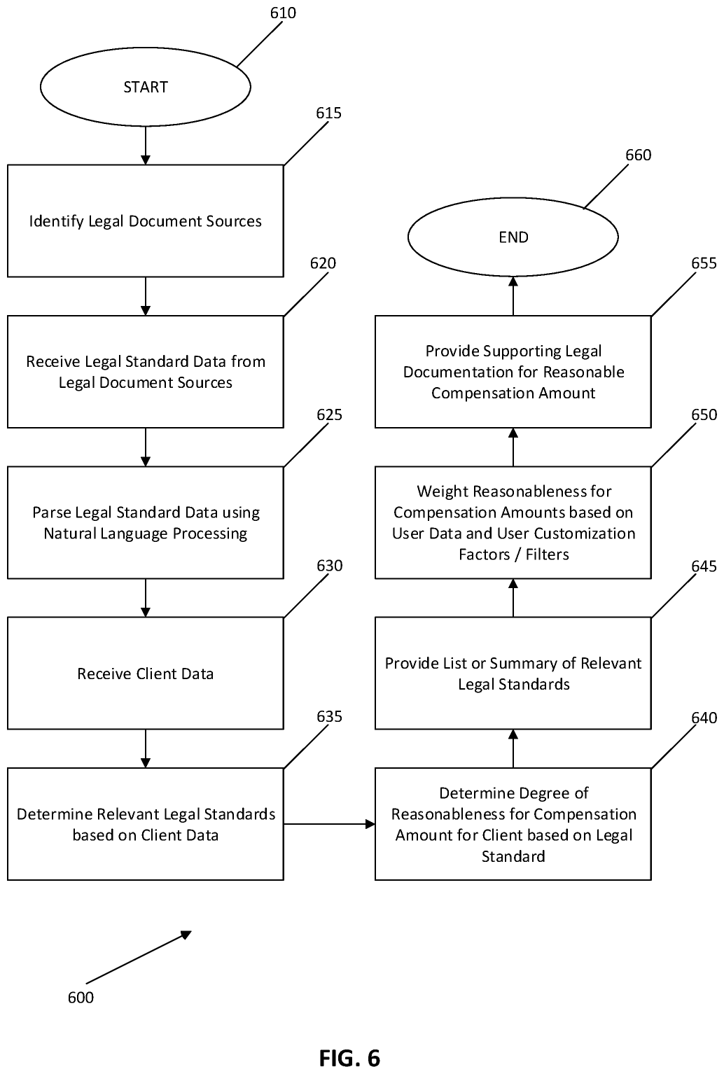

FIG. 6 illustrates an example flow chart for a method of automatic integration of legal standards for a system of compensation estimation, according to various embodiments. As shown, the method 600 may begin at starting block 610 and proceed to stage 615 where legal standard data is received, such as from a legal data source or database. For example a request to a server hosting court case data may be made and textual data related to court case holdings can be received. However, any legal data may generally be mapped to user data, client data, and/or external data.

From stage 615 where the legal data is received, the method 600 may proceed to stage 620 where the legal standard data is parsed to determine one or more legal standards. For example, natural language processing may be used to identify relationships between keywords, values, and terms in court case data. Keywords, values, and terms can correspond to user data types, may be manually selected, or may be automatically determined using machine learning to determine rules or standards relating reasonableness of compensation of an entity in a court case to corresponding values of user data types for the entity in the court case.

From stage 620 where the legal standard data is parsed, the method 600 may proceed to stage 625 where user data is received. In various situations, data values for an actual or theoretical user or client can be received, or in some cases one or more profiles may be received. In some cases, user data is automatically fetched from a user device or input by a user and received from the user or user device.

From stage 625 where the user data is received, the method 600 may proceed to stage 630 where user or client data is evaluated by the one or more legal standards to determine a set of relevant legal standards. For example, values for various user data types can be compared to values for the same data types belonging to entities in a court case of the textual legal source data. Relevance can be determined by matching or determining similarity between values. Data types may be weighted. For example, geographical location, job title, and industry may be given more weight than, for example, user age or number of shareholders of a company in determining relevance of a legal standard.

In some embodiments, it may be determined that a discrete number of legal standards are most applicable for a user based on, for example, an industry or compensation amount. A selection of the legal standards determined to be most relevant may be used. For example, 1-7 legal standards may be most applicable to the user based on a job type, gross receipts, geographical area, experience level of the user, and/or other aspects. In such cases, the 1-7 (or more) standards would be used and provided to the user in a report.

From stage 630 where the user data is evaluated, the method 600 may proceed to stage 635 where a degree of reasonableness for a compensation amount of the user or client data is determined. For example, a user profile or a “Like Me” profile can be evaluated by relevant legal standards to determine whether the compensation amount of that profile is likely reasonable or likely unreasonable. This may be used to as a basis to support whether a given amount for a “Like Me” profile is reasonable. By aggregating information about compensation amounts and degrees of reasonableness for “Like Me” profiles, an estimated range for a particular degree of reasonableness can be determined based on a high and low compensation for “Like Me” profiles falling in the range. In some cases, external data may be used to adjust attributes of the “Like Me” data or the legal standards, such as to normalize comparison.

From stage 635 where the degrees of reasonableness for compensation amounts of the user or client data are determined, the method 600 may proceed to stage 640 where degrees of reasonableness for compensation amount are provided.

From stage 640 where the degrees of reasonableness are provided, the method 600 may proceed to stage 645 where summaries are provided for the relevant legal standards used to evaluate the user or client data. In some cases, the summaries may include hyperlinks to full text documents supporting the summaries and/or colors indicating the status of law (e.g. red for overturned, yellow for questionable, green for valid). From stage 645 where the summaries are provided, the method 600 may proceed to end at ending block 650.

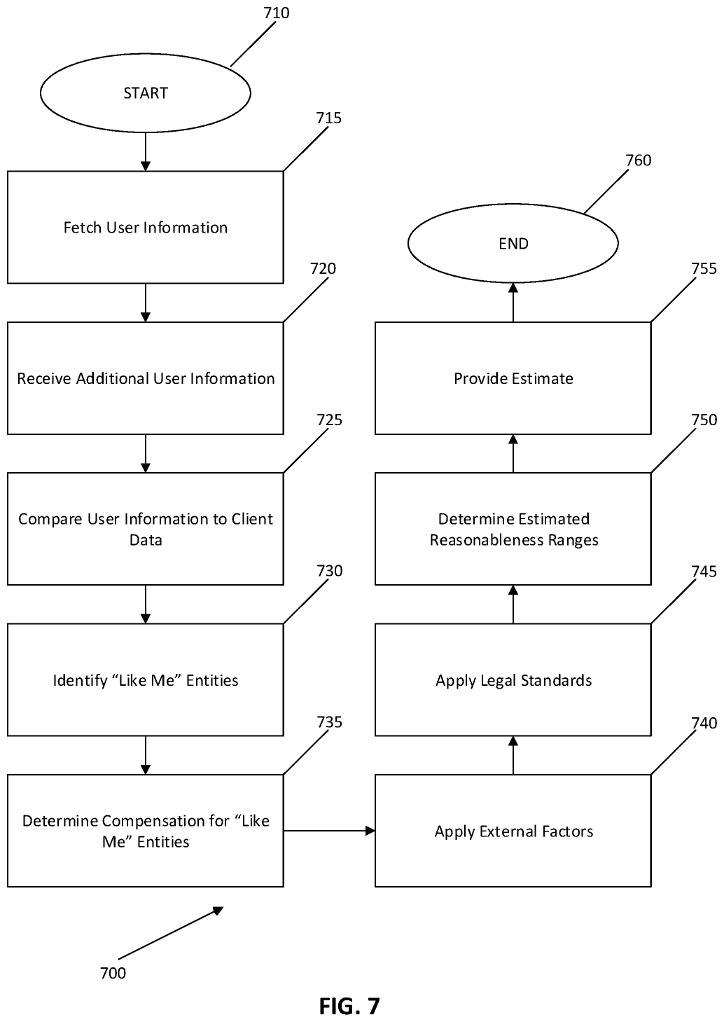

FIG. 7 illustrates an example flow chart for a method 700 of integrating “Like Me” data for a system of compensation estimation, according to various embodiments. The method 700 begins at starting block 710 and may proceed from starting block 710 to stage 720 where user information may be fetched. For example, some of the user information may be stored on a computing device or cloud location, such as by being saved in a user profile or account for an application or web service. In particular, fetching user information from accounting applications or services may save the user time in having to input information already available. In some cases, the user may have to approve such automatic importing, or may have to provide login credentials for use in fetching the user information.

From stage 720 where the user information is fetched, the method 700 may proceed to stage 725 where additional user information may be received. In some embodiments, a form may be presented to the user in a graphical user interface of a computing device, and the user information is input into the computing device. The prompt for user information may be a form or questionnaire that has been prepopulated in the case that some user information has been pre-fetched.

From stage 725 where the additional user information is received, the method 700 may proceed to stage 730 where user information is compared to a client data. For example, a client data database may include data for one or more client entities having one or more client data types that match a user data type. The client data may be raw or adjusted data.

From stage 730 where the user information is compared to the client data, the method 700 may proceed to stage 735 where “Like Me” entities are identified. For example, a plurality of “Like Me” entities may be identified by on one or more likenesses determined by a similar value for a user data type and a client data type for that entity.

From stage 735 where the “Like Me” entities are identified, the method 700 may proceed to stage 740 where external factors are applied. For example, an inflation rate, market trend data, demographic and/or geographical trend information, or other external factors may be applied to adjust a value of a “Like Me” compensation amount.

From stage 740 where the external factors are applied, the method 700 may proceed to stage 745 where legal standards are applied. For example, legal standards may be relevant to one or more of the “Like Me” entities in determining whether a compensation amount for that entity is reasonable. In some embodiments, a degree of reasonableness for the compensation amount of the “Like Me” entities may be provided, such by being colored according to degree or likelihood of reasonableness.

From stage 745 where the legal standards are applied, the method 700 may proceed to stage 750 where estimated reasonableness ranges are determined. For example, as previously described with respect to FIG. 2, a first range may be likely reasonable, a second range may be either reasonable or unreasonable, and a third range may be unreasonable based on the legal standards, the client data and the external data (or on adjusted client data).

From stage 750 where the estimated reasonableness ranges are determined, the method 700 may proceed to stage 755 where an estimate is provided. In various embodiments, the estimate may be a number, a range, a set of numbers or ranges, a histogram, a report, or other representation provided to a user. From stage 755 where the estimate is provided, the method 700 may proceed to conclude at ending block 760.

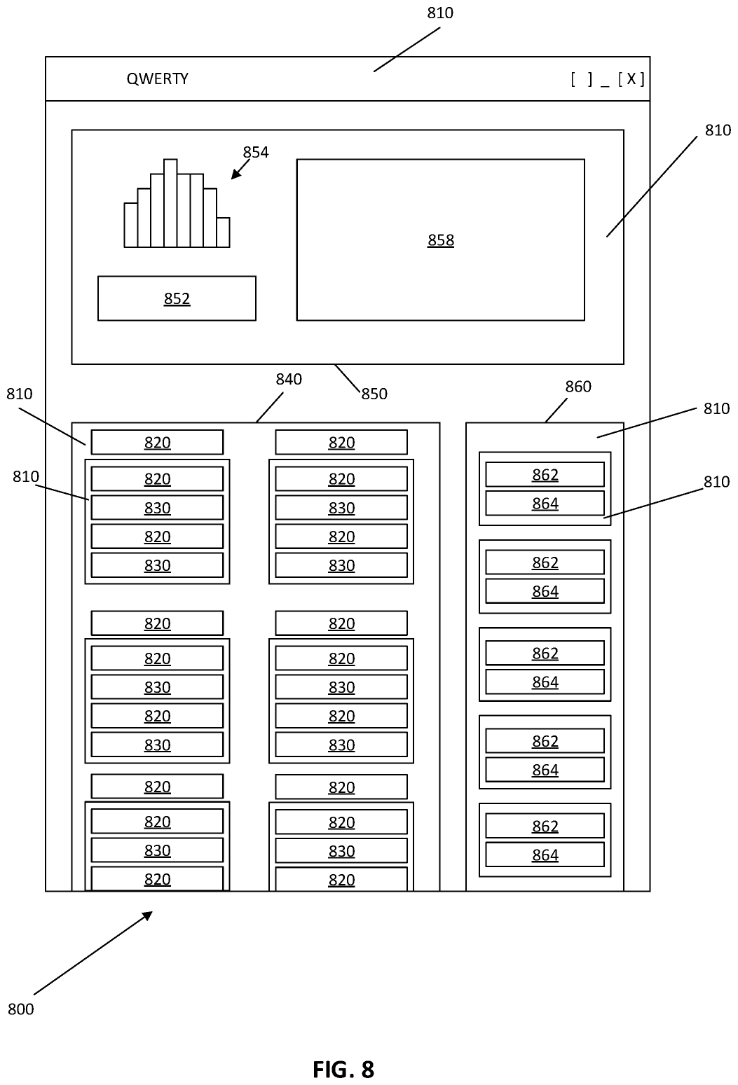

FIG. 8 illustrates a graphical user interface of a computing device for a system of reasonable compensation estimation, according to various embodiments. The graphical user interface 800 may include one or more graphical user interface elements 810 for displaying information in graphical format.

In various embodiments, the graphical user interface elements 810 may include labels 820 and value fields 830. The labels contain identifying information for describing the value fields, such as category or data types. The value fields allow input or display of values or selections for the data types. The fields may be used to display or input values related to, for example, user information or user customization factors. The graphical user interface elements can include a data group 840, a report group 850 and a legal standard group 860. The labels 820 may be textual labels. The fields 830 may include various text fields, drop down menus, sliders, radio button selectors, other graphical or textual elements, or other input types.

The data group may facilitate displaying user data or customization factors and filters. The labels and fields may be of this group may be sub-grouped by categories such as whether the labels and fields are demographic features, geographical information, industry type, books data, tax data, salary data, and/or business characteristics data, etc.

Demographic features may include, for example age, income, education, home ownership, marital status, family size, health-related information, or other demographic information. The geographical information can include city, state, region, country, coordinates, height above sea level, or other geographical information. Industry type may include an industry, field of an industry, sub-field, or other industry type. The books data may include a business code, a number of employees, and/or number of shareholders. The tax data may include a gross receipts, a net profit, and/or average stockholder distribution. The salary data may include a state and/or job title. The business characteristics data include a level of qualification, a scope of work, and/or a complexity of work. The market data may include a favorability rating for market conditions and/or selections of whether to consider one or more related court cases. It will be appreciated that this is an exemplary but non-exhaustive list of possible data types and sub-types.

The report group 850 may include an estimate element 852. The estimate 852 may include a value, values, range or ranges for degrees of reasonableness of compensation. The report group 850 may also include a histogram 854 or other graphical representation of compensation amounts for “Like Me” entities. The histogram 854 of some embodiments indicates a reasonableness degree for the “Like Me” entities. For example, a colorization indicating the degree of reasonableness (e.g. red for unreasonable, yellow for questionable, green for reasonable) can be applied to a graphical representation of the “Like Me” entities.

The report group 850 can also include an information box 858. The information box 858 of some embodiments allows the user to view client information about a “Like Me” entity by interacting with the histogram 854. The information box can also include summaries of the relevant legal standards and/or links to supporting documentation.

The legal standard group 860 can include titles 862 and summaries 864 for each legal standard relevant to the user. The titles 862 may include a hyperlink to a document supporting the legal standard, such as the full text of a court case. The summary 864 can include a textual summary of the legal standard, as well as why it applies to the user.

It will be appreciated that a graphical user interface 800 may have additional graphical user interface elements 810 present, or that some or all of the elements 810 may be otherwise arranged, configured, or omitted. It will be appreciated that the graphical user interface shown is exemplary in nature, and the various graphical user interface elements could be otherwise arranged, grouped, or numbered.

### Additional Considerations

Although several exemplary data types for the user data, client data, external data legal standard data include data type related to determining compensation for a business owner, it is anticipated that aspects of the present invention are equally applicable where reasonable compensation is estimated for compensation from a different entity than a user's business in other cases where “Like Me” entities are identifiable. For example, the user may be seeking an estimate for alimony, the client data may be data related to other alimony amounts for client entities, the external data may include data indicating a trend in alimony compensation amounts, and legal standards may be relevant in determining reasonableness of alimony compensation amounts for “Like Me” client entities. Other applications may include reasonable compensation amounts that are settlements of lawsuits based on “Like Me” plaintiffs or defendants, reasonable compensation amounts for talent contracts based on “Like Me” actors/actresses and production companies or based on athletes and team owners, and other situations.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of generating a compensation estimate for an entity, comprising:
receiving, at an estimation platform, a primary entity data set, a secondary entity data set, and a legal data set including a plurality of court cases involving reasonableness of compensation, the primary entity data set comprising data about a primary entity, and the secondary entity data set comprising data about a secondary entity selected based on matching a first value for the primary entity to a like value for the secondary entity;
cleaning the data about the primary entity to remove sensitive information about the primary entity;
determining a compensation amount for the secondary entity;
identifying a court case of the plurality of court cases as relevant by matching one or more values for the primary entity data set with one or more like values associated with a party of the court case;
determining that the court case supports reasonableness of the compensation amount by determining that the compensation amount is equal to or lower than a corresponding compensation amount found reasonable in the court case;
based on the determining that the court case supports reasonableness of the compensation amount, generating an initial compensation estimate for the primary entity based on the compensation amount and including a reference to the court case;
providing the initial compensation estimate for the primary entity in a user interface on a display;
receiving feedback data regarding the initial compensation estimate; and
generating an updated estimate based on the initial compensation estimate and the feedback data.

2. The method of claim 1, further comprising
prompting the primary entity for at least one customization factor comprising one or more selections or deselections of a given legal standard or a given secondary entity; and
automatically adjusting the initial compensation estimate based on the one or more selections or deselections.

3. The method of claim 1, further comprising:
identifying a plurality of secondary entities based on a plurality of likenesses between the primary entity data set and the secondary entity data set, the likenesses being determined by tax return data provided by the plurality of secondary entities to at least one application of a suite of products associated with the estimation platform; and
generating a plurality of profiles for the plurality of secondary entities, each profile including a compensation amount and a degree of reasonableness.

4. (canceled)

5. The method of claim 1, wherein the primary entity data set is received at the estimation platform from a first device; and the secondary entity data set is identified by comparing the primary entity data set with client data included in a client database to identify, in the client database, secondary entity data having a secondary entity data type matching a primary entity data type of the primary entity data set.

6. (canceled)

7. The method of claim 1, wherein the display is associated with a computing device, and the data about the primary entity is input into the computing device.

8. The method of claim 7, further comprising automatically importing user information from a service having access to stored user information, and including the imported user information as prepopulated primary entity data.

9. The method of claim 1, further comprising:
receiving an external data set including data automatically parsed from networked data sources related to at least one of the group consisting of: bureau of labor data, market data, and economic data;
determining that the court case supports reasonableness of the compensation amount comprises adjusting the compensation amount found reasonable in the court case based on the external data set to define an adjusted compensation amount; and
determining that the compensation amount for the secondary entity is equal to or lower than the adjusted compensation amount.

10. A non-transitory computer readable storage medium comprising instructions, that when executed by a processor, cause the processor to perform a method of generating a compensation estimate for an entity, the method comprising:
receiving, at an estimation platform, a primary entity data set, a secondary entity data set, and a legal data set including a plurality of court cases involving reasonableness of compensation, the primary entity data set comprising data about a primary entity, and the secondary entity data set comprising data about a secondary entity selected based on matching a first value for the primary entity to a like value for the secondary entity;
cleaning the data about the primary entity to remove sensitive information about the primary entity;
determining a compensation amount for the secondary entity;
identifying a court case of a plurality of court cases as relevant by matching one or more values for the primary entity data set with one or more like values associated with a party of the court case;
determining that the court case supports reasonableness of the compensation amount by determining that the compensation amount is equal to or lower than a corresponding compensation amount found reasonable in the court case;
based on determining that the court case supports reasonableness of the compensation amount, generating an initial compensation estimate for the primary entity based on the compensation amount and including a reference to the court case;
providing the initial compensation estimate in a user interface on a display that is in electrical communication with the processor;
receiving feedback data regarding the initial compensation estimate; and
generating an updated estimate based on the initial compensation estimate and the feedback data.

11. The non-transitory computer readable storage medium of claim 10, further comprising prompting the primary entity for at least one customization factor comprising one or more selections or deselections of a given legal standard or a given secondary entity, and automatically adjusting the initial compensation estimate based on the one or more selections or deselections.

12. The non-transitory computer readable storage medium of claim 10, further comprising:
identifying a plurality of secondary entities based on a plurality of likenesses between the primary entity data set and the secondary entity data set, the likenesses being determined by tax return data provided by the plurality of secondary entities to at least one application of a suite of products associated with the estimation platform; and
generating a plurality of profiles for the plurality of secondary entities, each profile including a compensation amount and a degree of reasonableness.

13. (canceled)

14. The non-transitory computer readable storage medium of claim 10, wherein the primary entity data set is received at the estimation platform from a first device; and the secondary entity data set is identified by comparing the primary entity data set with client data included in a client database to identify, in the client database, secondary entity data having a secondary entity data type matching a primary entity data type of the primary entity data set.

15. The non-transitory computer readable storage medium of claim 10, wherein the primary entity data set includes primary entity data that is input into a computing device, the display is associated with the computing device, and the method further comprises automatically detecting given primary entity data on the computing device.

16. A system, comprising:
a memory having executable instructions stored thereon;
a display; and
a processor configured to execute the executable instructions to cause the system to:
receive, at an estimation platform, a primary entity data set, a secondary entity data set, and a legal data set including a plurality of court cases involving reasonableness of compensation, the primary entity data set comprising data about a primary entity, and the secondary entity data set comprising data about a secondary entity selected based on matching a first value for the primary entity to a like value for the secondary entity;
determine a compensation amount for the secondary entity;
clean the data about the primary entity to remove sensitive information about the primary entity;
identify a court case of a plurality of court cases as relevant by matching one or more values for the primary entity data set with one or more like values associated with a party of the court case;
determine that the court case supports reasonableness of the compensation amount by determining that the compensation amount is equal to or lower than a corresponding compensation amount found reasonable in the court case;
based on determining that the court case supports reasonableness of the compensation amount, generate an initial compensation estimate for the primary entity based on the compensation amount and including a reference to the court case;
provide the initial compensation estimate in a graphical user interface on the display;
receive feedback data regarding the initial compensation estimate; and
generate an updated estimate based on the initial compensation estimate and the feedback data.

17. The system of claim 16, wherein identifying the secondary entity is based on an at least one customization factor comprising one or more selections or deselections of a given legal standard or a given secondary entity, and the executable instructions further cause the system to:
prompt the primary entity for the at least one customization factor; and
automatically adjust the initial compensation estimate based on the one or more selections or deselections.

18. The system of claim 16, wherein the executable instructions further cause the system to identify a plurality of secondary entities based on a plurality of likenesses between the primary entity data set and the secondary entity data set the likenesses being determined by tax return data provided by the plurality of secondary entities to at least one application of a suite of products associated with the estimation platform; and
generate a plurality of profiles for the plurality of secondary entities, each profile including a compensation amount and a degree of reasonableness.

19. (canceled)

20. The system of claim 16, wherein the primary entity data set is received at the estimation platform from a first device; and the secondary entity data set is identified by comparing the primary entity data set with client data included in a client database to identify, in the client database, secondary entity data having a secondary entity data type matching a primary entity data type of the primary entity data set.
